(19) United States
(12) Patent Application Publication
(10) Pub. No.: US 2025/0149789 A1
(43) Pub. Date: May 8, 2025

(54) INTEGRATED DIRECTIONAL ULTRAWIDEBAND PULSE GENERATOR FOR HIGH-POWER ELECTROMAGNETIC PULSE RADIATION

(71) Applicant: ELECTRONICS AND TELECOMMUNICATIONS RESEARCH INSTITUTE, Daejeon (KR)

(72) Inventors: Up NAMKOONG, Daejeon (KR); Jae-Yeop JEONG, Daejeon (KR); Jin-Ha YOO, Daejeon (KR)

(21) Appl. No.: 18/929,951

(22) Filed: Oct. 29, 2024

(30) Foreign Application Priority Data
Nov. 3, 2023 (KR) 10-2023-0150837
Sep. 26, 2024 (KR) 10-2024-0130907

(51) Int. Cl. H01Q 5/25; H01Q 9/16

(52) U.S. Cl. CPC H01Q 5/25; H01Q 9/16

(57) ABSTRACT

Disclosed herein is an integrated ultrawideband pulse generator for high-power electromagnetic pulse radiation. The integrated ultrawideband pulse generator may include an outer casing having openings formed on both sides, a pair of antenna bodies installed to adhere to the inner side of the openings on both sides of the outer casing, a pair of directional electrodes attached to the pair of antenna bodies and facing each other at a predetermined spacing inside the outer casing, and a pair of covers for sealing the openings on both sides of the outer casing.

### CROSS REFERENCE TO RELATED APPLICATIONS

This application claims the benefit of Korean Patent Applications No. 10-2023-0150837, filed Nov. 3, 2023, and No. 10-2024-0130907, filed Sep. 26, 2024, which are hereby incorporated by reference in their entireties into this application.

### BACKGROUND OF THE INVENTION

### 1. Technical Field

The disclosed embodiment relates to an electrode structure for maximizing radiation directivity in a spark gap switch, which is a high-power switching element.

### 2. Description of Related Art

High-power electromagnetic pulse generators may be classified into narrowband (high-power microwave) electromagnetic pulse generators, midband (damped sinusoid) electromagnetic pulse generators, and ultrawideband electromagnetic pulse generators depending on frequency bandwidth.

The narrowband electromagnetic pulse generator has a structure that generates an electromagnetic pulse using the motion of an electron beam that is given high kinetic energy by applying high voltage, and generates a pulse having a pulse width of several tens of nanoseconds or more and having narrow frequency bandwidth.

The midband or ultrawideband electromagnetic pulse generator has a structure that generates an electromagnetic pulse using an instantaneous switching device by applying high voltage, and generates a pulse having wide frequency bandwidth with a rise time of less than a nanosecond.

In order to generate a ultrawideband electromagnetic pulse, high-voltage ultrafast switching technology for generating a high-voltage fast pulse and antenna technology for efficiently radiating ultrawideband frequency components without loss are very important.

Generally, the ultrawideband electromagnetic pulse generator uses a structure in which a switch and an antenna are separated, but the generation structure may be easily implemented using an integrated type that combines the switch and the antenna.

### SUMMARY OF THE INVENTION

An object of the disclosed embodiment is to maximize efficiency of an integrated ultrawideband pulse generator and minimize the effect on other electronic devices.

Another object of the disclosed embodiment is to propose an electrode structure for maximizing radiation directivity in a spark gap switch, which is a high-power switching element, in an integrated ultrawideband pulse generator.

An integrated ultrawideband pulse generator for high-power electromagnetic pulse radiation according to an embodiment may include an outer casing having openings formed on both sides, a pair of antenna bodies installed to adhere to an inner side of the openings formed on both sides of the outer casing, a pair of directional electrodes attached to the pair of antenna bodies and facing each other at a predetermined spacing inside the outer casing, and a pair of covers for sealing the openings on both sides of the outer casing.

Here, the pair of directional electrodes may be fabricated such that facing surfaces thereof form an exponential shape, a linear shape, or a spherical shape when viewed from a side.

Here, in the pair of directional electrodes, a spark generation area on the facing surfaces may be fabricated to form a flat or curved surface.

Here, the pair of directional electrodes may include electrode protrusions attached to a spark generation area on the facing surfaces.

Here, edges of the pair of directional electrodes may be fabricated with a blended structure.

Here, the pair of directional electrodes may be fabricated with an aluminum material, and the spark generation area may be fabricated with a material including one of copper, tungsten, copper-tungsten, and molybdenum.

Here, the size and spacing of the pair of directional electrodes may be set depending on a frequency and a discharge voltage.

An integrated ultrawideband pulse generator for high-power electromagnetic pulse radiation according to an embodiment radiates a high-voltage ultrawideband pulse when high-voltage pulse power is applied, and may include a pair of directional electrodes facing each other at a predetermined spacing.

Here, the integrated ultrawideband pulse generator may further include an outer casing having openings formed on both sides, a pair of antenna bodies installed to adhere to an inner side of the openings on both sides of the outer casing, and a pair of covers for sealing the openings on both sides of the outer casing, and the pair of antenna bodies may be attached to the pair of directional electrodes.

Here, the pair of directional electrodes may be fabricated such that facing surfaces thereof form an exponential shape, a linear shape, or a spherical shape when viewed from a side.

Here, in the pair of directional electrodes, a spark generation area on the facing surfaces may be fabricated to form a flat or curved surface.

Here, the pair of directional electrodes may include electrode protrusions attached to a spark generation area on the facing surfaces.

Here, edges of the pair of directional electrodes may be fabricated with a blended structure.

Here, the pair of directional electrodes may be fabricated with an aluminum material, and the spark generation area may be fabricated with a material including one of copper, tungsten, copper-tungsten, and molybdenum.

Here, the size and spacing of the pair of directional electrodes may be set depending on a frequency and a discharge voltage.

### BRIEF DESCRIPTION OF THE DRAWINGS

The above and other objects, features, and advantages of the present disclosure will be more clearly understood from the following detailed description taken in conjunction with the accompanying drawings, in which:

FIG. 1 is a view for explaining a system configuration using an integrated ultrawideband pulse generator for high-power electromagnetic pulse radiation according to an embodiment;

FIGS. 2 and 3 are structural diagrams of a typical integral ultrawideband pulse generator;

FIGS. 4 to 7 are exemplary views of the electrode structure of a typical integrated ultrawideband pulse generator;

FIG. 8 is an exemplary view of a structure in which an integrated ultrawideband pulse generator and a reflector are combined;

FIGS. 9 and 10 are structural diagrams of an integrated ultrawideband pulse generator for high-power electromagnetic pulse radiation according to an embodiment;

FIGS. 11 to 13 are exemplary views of the shape of a directional electrode according to an embodiment;

FIG. 14 is a configuration diagram for an electric field measurement simulation in an integrated ultrawideband pulse generator for high-power electromagnetic pulse radiation according to an embodiment;

FIG. 15 is a view of the H-plane and E-plane of a peak electric-field pattern of a ultrawideband pulse generator designed according to an embodiment;

FIG. 16 is a view of an electric field pulse output at a distance of 100 m over time;

FIG. 17 is a view of the spectrum of a pulse received at a distance of 100 m;

FIG. 18 is a view of a form combined with a reflector; and

FIG. 19 is a view of comparison of electric fields output over time at a distance of 100 m when combined with a reflector.

### DESCRIPTION OF THE PREFERRED EMBODIMENTS

The advantages and features of the present disclosure and methods of achieving them will be apparent from the following exemplary embodiments to be described in more detail with reference to the accompanying drawings. However, it should be noted that the present disclosure is not limited to the following exemplary embodiments, and may be implemented in various forms. Accordingly, the exemplary embodiments are provided only to disclose the present disclosure and to let those skilled in the art know the category of the present disclosure, and the present disclosure is to be defined based only on the claims. The same reference numerals or the same reference designators denote the same elements throughout the specification.

It will be understood that, although the terms “first,” “second,” etc. may be used herein to describe various elements, these elements are not intended to be limited by these terms. These terms are only used to distinguish one element from another element. For example, a first element discussed below could be referred to as a second element without departing from the technical spirit of the present disclosure.

The terms used herein are for the purpose of describing particular embodiments only and are not intended to limit the present disclosure. As used herein, the singular forms are intended to include the plural forms as well, unless the context clearly indicates otherwise. It will be further understood that the terms “comprises,” “comprising,”, “includes” and/or “including,” when used herein, specify the presence of stated features, integers, steps, operations, elements, and/or components, but do not preclude the presence or addition of one or more other features, integers, steps, operations, elements, components, and/or groups thereof.

Unless differently defined, all terms used herein, including technical or scientific terms, have the same meanings as terms generally understood by those skilled in the art to which the present disclosure pertains. Terms identical to those defined in generally used dictionaries should be interpreted as having meanings identical to contextual meanings of the related art, and are not to be interpreted as having ideal or excessively formal meanings unless they are definitively defined in the present specification.

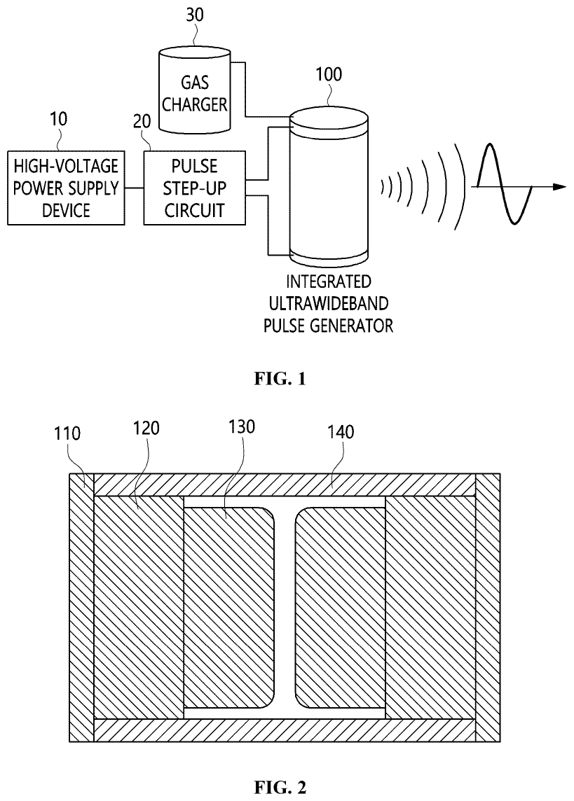

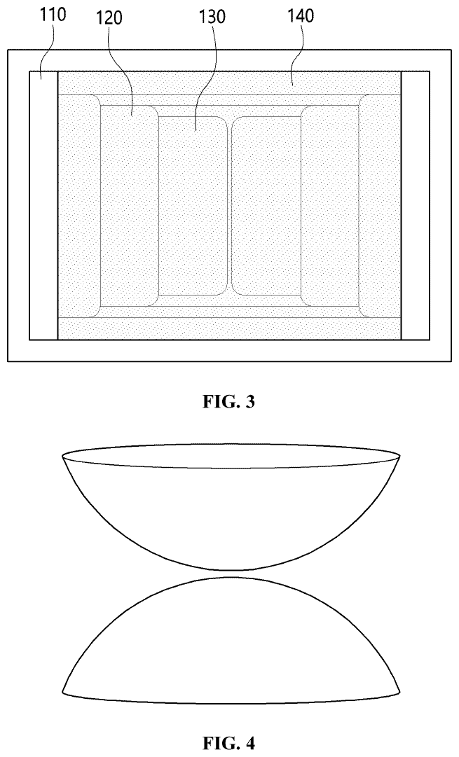

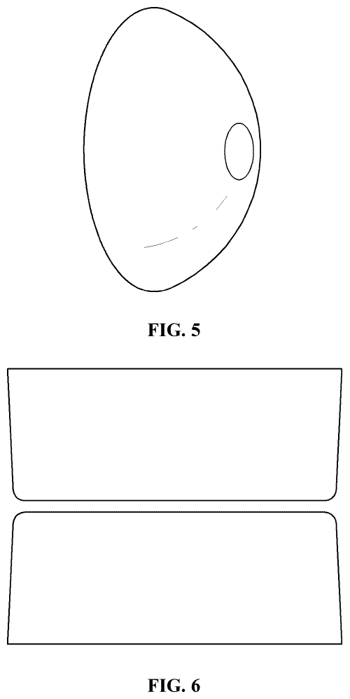

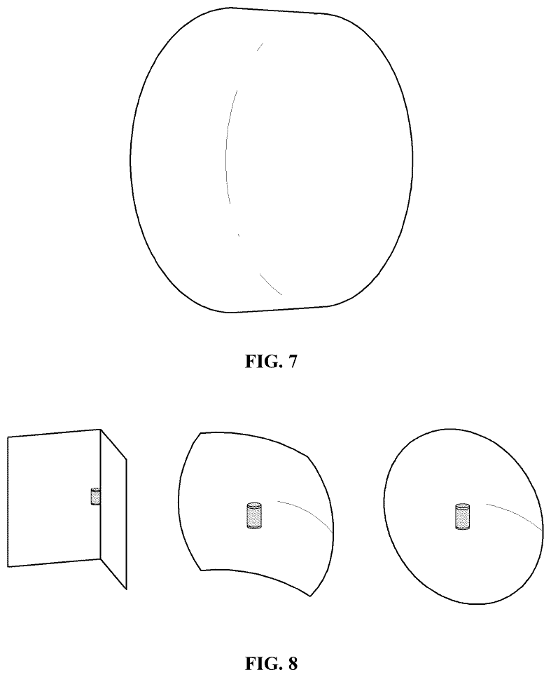

FIG. 1 is a view for explaining a system configuration that uses an integrated ultrawideband pulse generator for high-power electromagnetic pulse radiation, FIGS. 2 and 3 are structural diagrams of a typical integrated ultrawideband pulse generator, FIGS. 4 to 7 are exemplary views of the electrode structure of a typical integrated ultrawideband pulse generator, and FIG. 8 is an exemplary view of a structure for combining a reflector to an integrated ultrawideband pulse generator.

Referring to FIG. 1, an integrated ultrawideband pulse generator for high-power electromagnetic pulse radiation according to an embodiment may operate by being connected with a high-voltage power supply device 10, a pulse step-up circuit 20, and a gas charger 30.

That is, the integrated ultrawideband pulse generator 100 for high-power electromagnetic pulse radiation, to which high-voltage pulse power generated by the high-voltage power supply device 10 and the pulse step-up circuit 20 is applied, may radiate a high-voltage ultrawideband pulse.

Here, the pulse step-up circuit 20 may be implemented using a Marx generator, a Tesla transformer, and the like.

Here, in order to increase the internal discharge voltage of the integrated ultrawideband pulse generator 100 for high-power electromagnetic pulse radiation, high-pressure gas is input thereto by connecting the gas charger thereto.

FIGS. 2 and 3 are structural diagrams of a typical integrated ultrawideband pulse generator.

Referring to FIGS. 2 and 3, a typical integrated ultrawideband pulse generator 100 for high-power electromagnetic pulse radiation may include an outer casing 110, a pair of antennas 120, a pair of electrodes 130, and a cover 140.

The pair of electrodes 130 may generate sparks by being spaced apart from each other at a predetermined spacing.

The pair of antenna bodies 120 in the form of a fat dipole may generate an electromagnetic pulse.

The outer casing 110 houses the pair of antenna bodies 120 and the pair of electrodes 130 therein. In order to increase the internal discharge voltage, the outer casing 110 is formed with a structure combined with the cover such that high-pressure gas, insulating oil, etc. can be sealed.

However, in order to couple the pair of electrodes 130 to the pair of antennas 120, the pair of electrodes 130 have a cylindrical, biconical, or hemispherical shape, as shown in FIGS. 4 to 7, which imparts an omnidirectional characteristic thereto.

The integrated ultrawideband pulse generator determines a high resonant frequency by adjusting the size of the facing electrode surfaces and the spacing between the electrodes and determines a low resonant frequency depending on the diameter and length of the antenna body.

The two resonant frequencies are combined, so ultrawideband characteristics are exhibited in the frequency spectrum.

However, the existing integrated ultrawideband electromagnetic pulse generator is generally implemented in the form of a fat dipole, but it has the characteristics of omnidirectional radiation, which affects nearby electronic devices and causes a limitation in obtaining a high output electric field.

Therefore, the existing integrated ultrawideband electromagnetic pulse generator is used in combination with any of various types of reflectors, such as parabolic and corner reflectors, as illustrated in FIG. 8, to obtain a high output electric field.

However, even though the output field is amplified using a reflector, as described above, the ultrawideband pulse generator has a limitation in increasing the output field due to the low directivity thereof, so it is necessary to change the internal structure in order to improve the directivity.

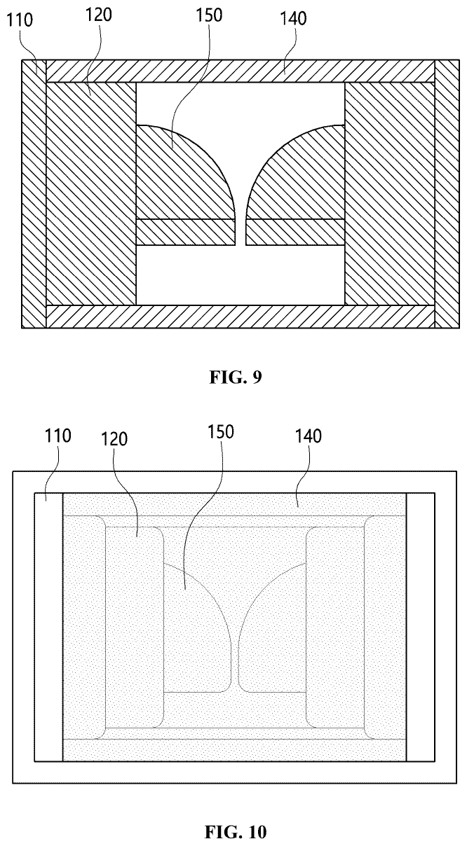

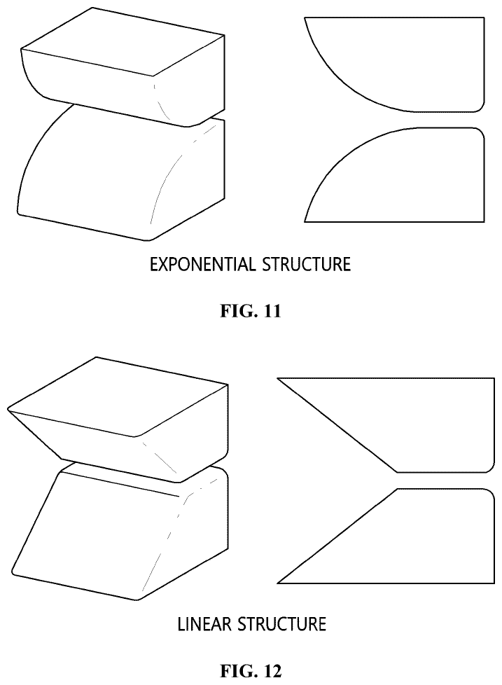

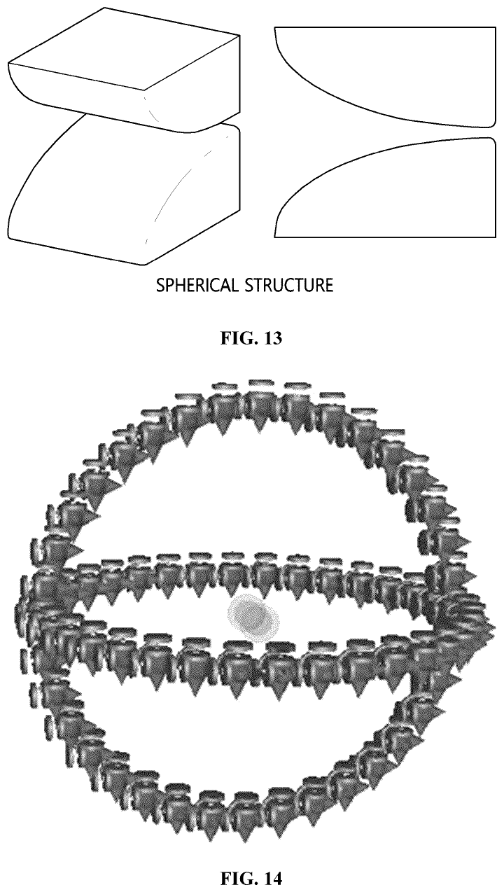

FIGS. 9 and 10 are structural diagrams of an integrated ultrawideband pulse generator for high-power electromagnetic pulse radiation according to an embodiment, and FIGS. 11 to 13 are exemplary views of the shape of a directional electrode according to an embodiment.

Referring to FIGS. 9 and 10, the integrated ultrawideband pulse generator for high-power electromagnetic pulse radiation according to an embodiments may include an outer casing 140 having openings formed on both sides, a pair of antenna bodies 120 installed to adhere to the inner side of the openings on both sides of the outer casing 140, a pair of directional electrodes 150 attached to the pair of antenna bodies 120 and facing each other at a predetermined spacing inside the outer casing 140, and a pair of covers 110 that seal the openings on both sides of the outer casing 140.

Here, the pair of directional electrodes 150 may be fabricated such that the facing surfaces thereof have exponential, linear, or spherical shapes when viewed from the side, as illustrated in FIGS. 11 to 13. As a result, directivity may be increased compared to existing electrodes.

Also, in order to improve the directivity, only the surfaces in the radiating direction are formed to have exponential, linear, or spherical shapes, and the other surfaces are cut.

Here, in the pair of directional electrodes 150, a spark generation area on the facing surfaces may be fabricated to form a flat or curved surface.

Here, the pair of directional electrodes 150 may include electrode protrusions attached to the spark generation area on the facing surfaces to ensure stable discharge of the electrodes.

Here, the edges of the pair of directional electrodes 150 may be fabricated with a blended structure to ensure stable discharge.

Here, the pair of directional electrodes 150 may be fabricated with an aluminum material, and the spark generation area may be fabricated with a material including one of copper, tungsten, copper-tungsten, and molybdenum, which have high durability.

Here, the size and spacing of the pair of directional electrodes 150 may be set depending on the frequency and the discharge voltage.

Meanwhile, the length and diameter of the antenna bodies 120 are adjusted depending on the frequency to be designed.

Here, the antenna bodies 120 are fabricated using metal such as aluminum.

Also, the antenna bodies 120 may include a structure such as an O-ring to adhere the cover 110 and the outer casing 140 to each other in order to prevent gas leakage.

Also, the cover 110 is adhered to the outer casing 140 to prevent gas leakage. The cover 110 may be fixed to the outer casing 140 using screws.

The cover 110 is fabricated using metal such as aluminum.

The cover 110 requires a connector through which gas can be inserted and a port through which high-voltage power can be applied.

Finally, the material of the outer casing 140 uses dielectrics, such as Ultem, Fiber Reinforced Polymers (FRP), Polycarbonate (PC), Polypropylene (PP), etc., for radiation of an electromagnetic pulse.

Also, the outer casing 140 is assembled with a cover and screws, and the inner diameter thereof matches the diameter of the antenna body such that the outer casing 140 adheres to the antenna body.

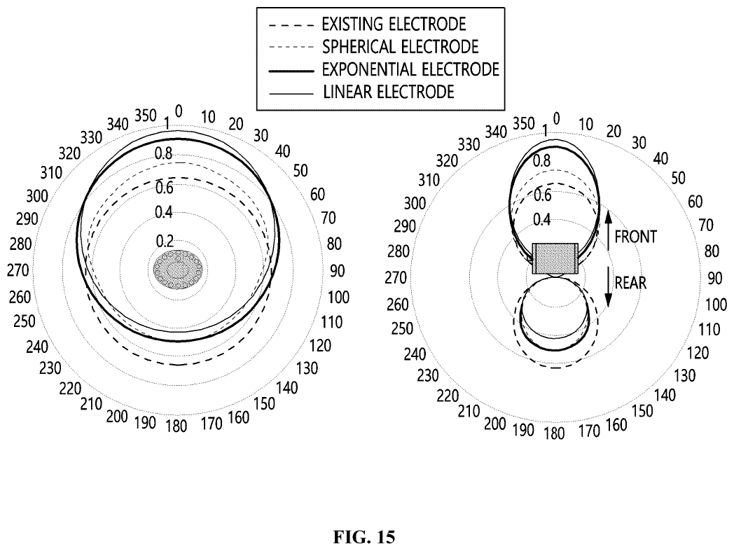

FIG. 14 is a configuration diagram for an electric field measurement simulation in an integrated ultrawideband pulse generator for high-power electromagnetic pulse radiation according to an embodiment, and FIG. 15 is a view in which the H-plane and E-Plane of a Peak Electric-field Pattern (PEFP) are illustrated on the left and right sides, respectively.

Because the output of the integrated ultrawideband pulse generator for high-power electromagnetic pulse radiation according to the above-described embodiment is in the form of a pulse, the directivity performance is checked by observing the H-plane and the E-plane using the peak electric-field pattern.

The integrated ultrawideband pulse generator is place as shown in FIG. 14, and the result is simulated by measuring an electric field using a probe at a distance of 100 m with 10-degree intervals.

The peak electric-field pattern represents the peak magnitude of the electric field output at each angle when the input at a distance of 100 m is 1 V, as shown in FIG. 15.

As the tool used for the electromagnetic pulse simulation, CST Microwave Studio is used.

As shown in FIG. 15, it can be seen that the directivity of the ultrawideband pulse generator having a directional electrode is improved compared to the existing ultrawideband pulse generator having a general electrode.

When a directional electrode is used, the electric fields have different magnitudes in the front and rear directions, as shown in the peak electric-field pattern, and form a directional pattern by being skewed in one direction.

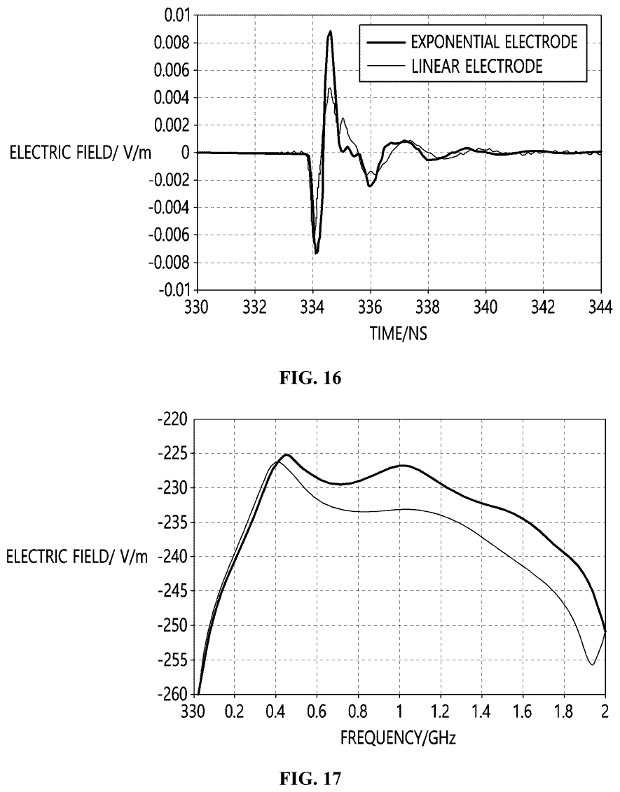

FIG. 16 is a view of an output electric-field pulse at a distance of 100 m, and FIG. 17 is a view of a pulse spectrum at a distance of 100 m.

A hemispherical electrode is used as the general electrode, and an exponential electrode is used as the directional electrode, and then the output electric field levels and spectrums are compared.

It can be seen that, when the output electric field strength is simulated using a probe at a distance of 100 m, the peak output value increases from 0.0063 to 0.009, as shown in FIGS. 16 and 17.

It is determined that the increase in the output results from the directivity and the increase in the high-frequency components in the frequency spectrum.

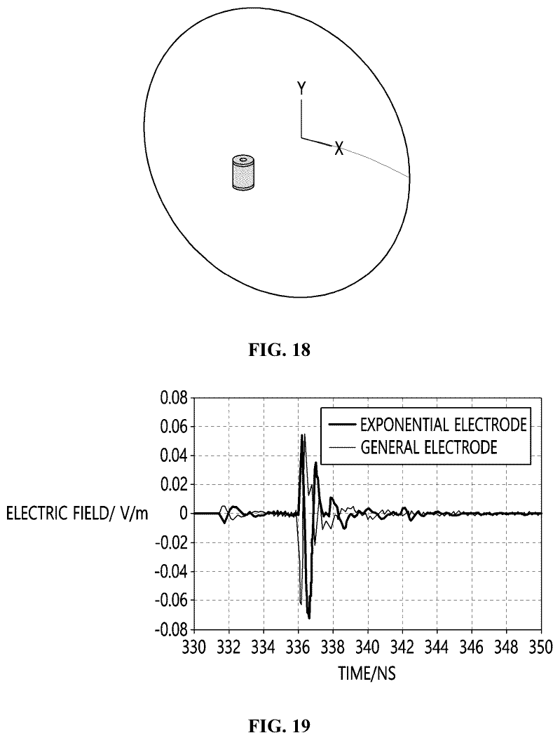

FIG. 18 is a view illustrating a form combined with a reflector, and FIG. 19 is a view for comparing output electric fields.

The electric fields that are output when a 1.8 m parabolic reflector is used to amplify the output electric field, as shown in FIG. 18, are compared.

As shown in FIG. 19, it can be seen that, when the directional electrode is used together with the parabolic reflector, the output electric field is 15% higher than before.

According to the disclosed embodiment, efficiency of an integrated ultrawideband pulse generator may be maximized, and the effect on other electronic devices may be minimized.

The disclosed embodiment changes the structure of two opposite electrodes of a fat dipole antenna to various directional forms to impart directivity to the fat dipole antenna, thereby maximizing the radiation efficiency through a combination with a reflector and preventing omnidirectionality from damaging other electronic devices.

Although embodiments of the present disclosure have been described with reference to the accompanying drawings, those skilled in the art will appreciate that the present disclosure may be practiced in other specific forms without changing the technical spirit or essential features of the present disclosure. Therefore, the embodiments described above are illustrative in all aspects and should not be understood as limiting the present disclosure.

What is claimed is:

1. An integrated ultrawideband pulse generator for high-power electromagnetic pulse radiation, comprising:
an outer casing having openings formed on both sides;
a pair of antenna bodies installed to adhere to an inner side of the openings on both sides of the outer casing;
a pair of directional electrodes attached to the pair of antenna bodies and facing each other at a predetermined spacing inside the outer casing; and
a pair of covers for sealing the openings on both sides of the outer casing.

2. The integrated ultrawideband pulse generator of claim 1, wherein the pair of directional electrodes are fabricated such that facing surfaces thereof form an exponential shape, a linear shape, or a spherical shape when viewed from a side.

3. The integrated ultrawideband pulse generator of claim 2, wherein, in the pair of directional electrodes, a spark generation area on the facing surfaces is fabricated to form a flat or curved surface.

4. The integrated ultrawideband pulse generator of claim 2, wherein the pair of directional electrodes include electrode protrusions attached to a spark generation area on the facing surfaces.

5. The integrated ultrawideband pulse generator of claim 1, wherein edges of the pair of directional electrodes are fabricated with a blended structure.

6. The integrated ultrawideband pulse generator of claim 2, wherein:
the pair of directional electrodes are fabricated with an aluminum material, and
a spark generation area is fabricated with a material including one of copper, tungsten, copper-tungsten, and molybdenum.

7. The integrated ultrawideband pulse generator of claim 1, wherein a size and spacing of the pair of directional electrodes are set depending on a frequency and a discharge voltage.

8. An integrated ultrawideband pulse generator for high-power electromagnetic pulse radiation, configured to radiate a high-voltage ultrawideband pulse when high-voltage pulse power is applied, comprising:
a pair of directional electrodes facing each other at a predetermined spacing.

9. The integrated ultrawideband pulse generator of claim 8, further comprising:
an outer casing having openings formed on both sides;
a pair of antenna bodies installed to adhere to an inner side of the openings on both sides of the outer casing; and
a pair of covers for sealing the openings on both sides of the outer casing,
wherein the pair of antenna bodies are attached to the pair of directional electrodes.

10. The integrated ultrawideband pulse generator of claim 8, wherein the pair of directional electrodes are fabricated such that facing surfaces thereof form an exponential shape, a linear shape, or a spherical shape when viewed from a side.

11. The integrated ultrawideband pulse generator of claim 10, wherein, in the pair of directional electrodes, a spark generation area on the facing surfaces is fabricated to form a flat or curved surface.

12. The integrated ultrawideband pulse generator of claim 10, wherein the pair of directional electrodes include electrode protrusions attached to a spark generation area on the facing surfaces.

13. The integrated ultrawideband pulse generator of claim 8, wherein edges of the pair of directional electrodes are fabricated with a blended structure.

14. The integrated ultrawideband pulse generator of claim 8, wherein:
the pair of directional electrodes are fabricated with an aluminum material, and
a spark generation area is fabricated with a material including one of copper, tungsten, copper-tungsten, and molybdenum.

15. The integrated ultrawideband pulse generator of claim 8, wherein a size and spacing of the pair of electrodes are set depending on a frequency and a discharge voltage.
